(19) United States
(12) Patent Application Publication
(10) Pub. No.: US 2016/0057500 A1
(43) Pub. Date: Feb. 25, 2016

(54) METHOD AND SYSTEM FOR PRODUCING A PERSONALIZED PROJECT REPOSITORY FOR CONTENT CREATORS

(71) Applicant: THOMSON LICENSING, Issy Les Moulineaux (FR)

(72) Inventors: KEVIN BERSON, SHERMAN OAKS, CA (US); JOESPH CHRISTIAN GAMMILL, HUNTINGTON BEACH, CA (US); CHRISTOPHER RAMPEY, BELLEVUE, WA (US)

(73) Assignee: Thomson Licensing

(21) Appl. No.: 14/775,317

(22) PCT Filed: Jan. 2, 2014
(86) PCT No.: PCT/US14/10086

§ 371 Date: Sep. 11, 2015

Related U.S. Application Data
(60) Provisional application No. 61/824,955, filed on May 17, 2013.
(60) Provisional application No. 61/824,953, filed on May 17, 2013.
(60) Provisional application No. 61/824,951, filed on May 17, 2013.
(60) Provisional application No. 61/824,947, filed on May 17, 2013.

(51) Int. Cl. H04N 21/4788; H04N 21/4627; G06F 3/0484; H04N 21/81

(52) U.S. Cl. CPC H04N 21/4788; H04N 21/8133; H04N 21/4627; G06F 3/0484

(57) ABSTRACT

A personalized project repository for content creators using multimedia annotations on video production projects. The project repository may be an aggregation of multimedia annotations created by a content creator based on a set of access rules defined for the content creator, where the access rules limit the content creators ability to create multimedia annotation within video production projects.

### CROSS-REFERENCE TO RELATED APPLICATIONS

This application claims the benefit of U.S. Provisional Application 61/824,955, entitled “Video Player with Multi-Media Annotations”, filed May 17, 2013, U.S. Provisional Application 61/824,953, entitled “Video Player with Multi-Group Annotations”, filed May 17, 2013, U.S. Provisional Application 61/824,951, entitled “Video Player with Deck Controls”, filed May 17, 2013, and U.S. Provisional Application 61/824,947, entitled “Video Player with Comment Fast Forward and Reverse”, filed May 17, 2013, which are incorporated herein by reference.

### FIELD OF INVENTION

The present disclosure is directed towards creating a personalized project repository of contributions to audio/video production projects using multimedia annotation.

### BACKGROUND

Current on-line video sites do a very good job of serving audio/video content. However, there is a much greater story that can be told about the content creation process than merely the final work product showcased on current on-line video sites. For example, content creators have little ability to provide various ‘behind the scenes’ or ‘director's cut’ perspectives on the content to illustrate their technical roles in the content production, problems that were overcome during the production, inspiration that drove a particular frame, scene, or project, or general information that is unique to the content creator.

There are several individuals involved in the content creation process (e.g. directors, producers, actors, writers, editors, make-up artists, sound mixers, set designers, costume designers, lighting crew, location scouters, etc.) who may all work on several projects throughout their careers. Online professional social networks are one avenue where these content creators can network with others professionals to exchange email and view limited resumes of work and skills, which are usually limited to text or static design. However, visually illustrating their achievements is an individual effort which can be time consuming and very expensive. For example, these content creators create film reels or entire websites to showcase their skills and work as a resume of their accomplishments and past projects, and in many cases each must also consider copyrights and intellectual property ramifications of making such content publicly available when using content that may have been created during a particular production.

For these reasons, there exists a need for an integrated solution that allows content creators to network with other content creators, exchange ideas in a media rich environment, provide visually rich commentary on work product to illustrate their skills and contributions, and present a living interactive and visual resume of their work product in order to gain and/or build recognition and notoriety in particular fields that each content creator works in.

### BRIEF SUMMARY

Some embodiments provide a system and method for creating a personalized collaborative project repository. Some embodiments may receive multimedia content (e.g., video projects, short films, movies, etc.) along with an identification of several content collaborators involved in creating the multimedia content.

The content collaborators may be assigned a set of access rules that define annotation rights for each collaborator. The content collaborators may annotate the multimedia content with multimedia objects where the annotations allowed to be associated with the multimedia content may be restricted by the pre-defined limits established by the annotation rights of each content collaborator.

Some embodiments provide for the creation and display of a personalized project repository as an accumulation of the content collaborator's annotations and their corresponding sections of multimedia content.

The preceding Summary is intended to serve as a brief introduction to some embodiments of the present disclosure. It is not meant to be an introduction or overview of all inventive subject matter disclosed in this document. The Detailed Description that follows and the Drawings (or “Figures” or “FIGs.”) that are referred to in the Detailed Description will further describe some of the embodiments described in the Summary as well as other embodiments. Accordingly, to understand all the embodiments described by this document, a full review of the Summary, Detailed Description and the Drawings is needed.

### BRIEF DESCRIPTION OF THE DRAWINGS

The novel features of the disclosure are set forth throughout this specification. However, for purpose of explanation, some embodiments are set forth in the following drawings.

FIG. 1 illustrates an exemplary system that may be used to implement some embodiments;

FIG. 2 illustrates a flow chart of an exemplary process used by some embodiments;

FIG. 3 illustrates an exemplary profile of a content creator according to one embodiment;

FIG. 4 illustrates a flow chart of an exemplary process used in in some embodiments for creating a multimedia annotation;

FIG. 5 illustrates a block diagram of an exemplary system for implementing an application for creating a personalized project repository of some embodiments;

FIG. 6 illustrates an exemplary software architecture of a project repository application;

FIG. 7 illustrates a flow chart of a exemplary process used by some embodiments to define and store a personalized project repository application of some embodiments; and

FIG. 8 illustrates a schematic block diagram of an exemplary computer system with which some embodiments may be implemented.

### DETAILED DESCRIPTION

In the following detailed description, numerous details, examples, and embodiments are set forth and described. However, it will be clear and apparent to one skilled in the art that the disclosure is not limited to the embodiments set forth, and that the disclosed embodiments may be practiced without some of the specific details and examples discussed.

Several more detailed embodiments are described in the sections below. Section I provides a description of an exemplary system and methods that may be used in some embodiments of the present disclosure to create a personalized project repository for content creators. Section II describes a video player of some embodiments. Section III describes different implementations of multimedia annotations in some embodiments. Section IV describes a system and software architecture used in some embodiments. Lastly, Section V describes a computer system which implements some of the embodiments of the present disclosure.

### I. System Overview

Some embodiments of the present disclosure provide a system that is an integrated solution for content creators/collaborators (e.g. directors, producers, actors, writers, editors, make-up artists, sound mixers, set designers, costume designers, lighting crew, location scouters, etc.) to network with other content creators, exchange ideas in a media rich environment, provide visually rich commentary on work product to illustrates their skills and contributions, and present an ongoing visual resume of work in order to gain and/or build recognition and notoriety in particular fields that content creators works in.

This platform may allow for deeper conversations between content creators, content curators and the broader industry and fan communities by providing the stakeholders to tell ‘behind the scenes’ stories and/or share relevant materials with each other. Such conversations provide an insight to the rich process of content creation, as told from multiple perspectives. For example, a director might post a picture of a hotel that inspired the setting of a scene is his film or the director of photography might provide an audio track explaining how she captured a difficult underwater shot.

These perspectives may take the form of visual annotations to work product, which may be content from an ongoing project or a final video production. The visual annotations may be multimedia objects that could be one or a combination of text, audio, video, PDF files or images that may be visually attached on a video timeline of the content, for example. One skilled in the art would also appreciate that some embodiments of the system may also be adapted for other creative industries such as software entrepreneurs, architects, furniture makers and broad categories of freelancers, for example, that may be considered to be “creative makers”.

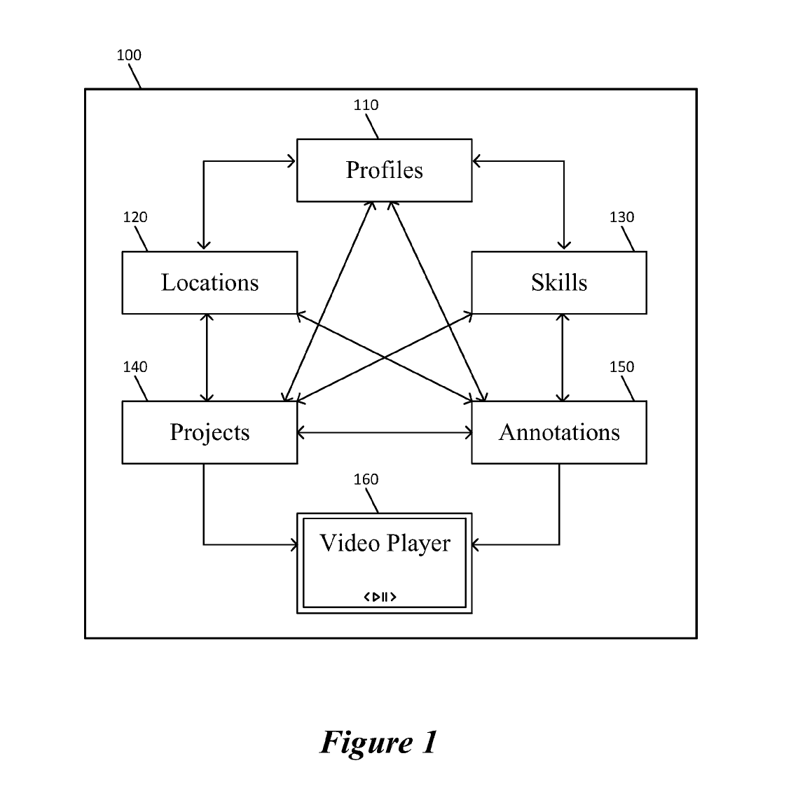

FIG. 1 illustrates an overview of an exemplary system 100 that may be used to implement some embodiments of the present disclosure. The system 100 may include several different interconnected databases including databases for user profiles 110, locations 120, skills 130, work product or projects 140, annotations 150, and a video player 160.

The profiles database 110 include all the profiles that content creators create in the system 100. These profiles can grow over time with annotations made on projects as well as locations and skills used while working on those projects. The continuous growth via interaction within the system of user profiles will be discussed in further detail below.

The locations database 120 may include several locations identified by content creators that were used during particular shoots. These locations may be linked to projects, annotations, and profiles. Each location in the locations database 120 may also be filled with several types of metadata or tags and other relevant information that may be used by location scouters while searching for locations to use in a video production. For example, the locations may be tagged with geographical identifiers such as zip codes, city, country, etc. as well as location types (e.g., office, home, stadium, church, jail, library, etc.) for easy filtering during a location scouting session. Other relevant information may include availability information, location contact information, images, or any relevant information regarding the capturing of different types of content used in a video production.

The skill database 130 may be a database of different skills content creators use in the course of the content creation process. This may not necessarily be related to intangible skills, and could also include the different types of gear/equipment (e.g., cameras, rigs, lighting) or hardware/software that is used during the content creation process. These skills may be linked to annotations on a project which may in turn populate into a content creator's profile to illustrate the level of expertise and use of different skills and/or equipment/gear/software/etc. used during the content creation process. Skills could also include certain types of visual styles and aesthetics that the creator has expertise in e.g. film noir, western, surreal, etc.

The projects database 140 may include all the various types of content uploaded to the system. Throughout this detailed description, projects may be used interchangeably with the terms content, production, video, photography, animation, video game or any combination thereof. Each project may also be associated with several verified content creators. Some of these content creators may have active profiles in the system while others may not. The content creators may be verified as a contributor to the project via a curator in charge of managing content in the system, through a third party such as a studio or verified online database of content creators and their respective work, via a listing of credits from the content itself, by verification provided by a pre-defined number of peers, by the content owner or any other means to verify that a content creator contributed to the production of that content. Once a content creator has been associated as a verified contributor to the content, he or she may contribute to that content by adding rich commentary using multimedia annotations.

Each project in the database 140 may be linked to several profiles (i.e. content creators who worked on that project), locations used to produce the content, skills/equipment used in to shoot the production, as well as all the annotations associated with that project.

The annotations database 150 includes all the multimedia annotations made in the system in association with a project. After creating an annotation the content creator may also be prompted to add tags or associations to the annotation such as location or skills relevant to the particular annotation. The creation and types of annotations that can be created and viewed alongside video production projects in the video player 106 will be discussed in greater detail in Section II.

One of ordinary skills in the art will recognize that the system 100 may be implemented in various different ways without departing from the scope of the disclosure. For instance, some of the databases may be implemented as a single database. In addition, one of ordinary skill in the art will recognize that several other databases or modules may also be incorporated into the system without departing from the scope of the present disclosure. For example, the system may also be further enriched by including a question and answer database related to projects, equipment reviews, general content creation methodologies, a job board, as well as a database of companies that may provide a wide array of services that are needed during the content creation process (e.g. post production, catering, recruiting, etc.). One of ordinary skill will understand that this type of information may easily be included into the system 100 and have linked interconnections with the other several modules or databases within the system 100.

As content/projects are uploaded to the system, there may be several criteria that will regulate who and how the content may to be annotated. For example, the owner of the content (e.g. a film production studio) will own intellectual property rights to the content and may not wish for the content to be readily available to the general public or even generally available to the content creators that contributed to the creation of the movie production. The platform may have restrictions imposed by the owner or curator of the content to prohibit the viewing of the production in its entirety and therefore limit the amount of time or amount of scenes which may be annotated within the production as a whole or limit the amount of time a content creator may annotate the content, among other limitations. In some cases, the content owner or curator may wish to limit annotation rights to a certain sub-set of verified content contributors (e.g., director, producer, lead actor, lead sound technician, etc.) rather than granting access rights to all verified content contributors. Alternatively, there may be instances when the content owner wants to allow all users within the system including the general public to comment and annotate his work.

To control access to the content, the content owner, a designated third party, or a content curator may define access rules to the content and annotation rights for content creators. For example, the content may only be viewable to verified and permitted content contributors in pre-defined increments (e.g., 15 seconds, 30 seconds, 1 minute). Furthermore, access rules may define how permitted content contributors are allowed to annotate the content with multimedia objects. For example, limits may be imposed on the number of annotations allowed by a content creator, the types of annotations (e.g., video, text, images, PDF, etc.), the length of the annotation, or the duration of viewable content in associations with an annotation (i.e. a temporal limit to the portion or particular scene of the media content to be associated with the annotation). The time limit on viewable content/scenes is one exemplary method that may be used so the content owner maintains control of how much of his video production is viewable thereby avoiding unwanted distribution of the content itself, which also allows the focus to be maintained on the content creators and their commentary.

These limits may be imposed automatically based on a content creator's title or reputation within the system 100, the content creator's contribution to the particular production, or the content creators role with respect to the production, among other criteria. The access rules assigned to a content creator for a particular project may be automatically determined by the system based on certain criteria as discussed above or they may be manually assigned by the content owner or curator of the content. In some instances, a content creator may also submit requests to the content owner or curator for initial annotation access, or to increase the amount of access previously defined by the system or content owner/curator.

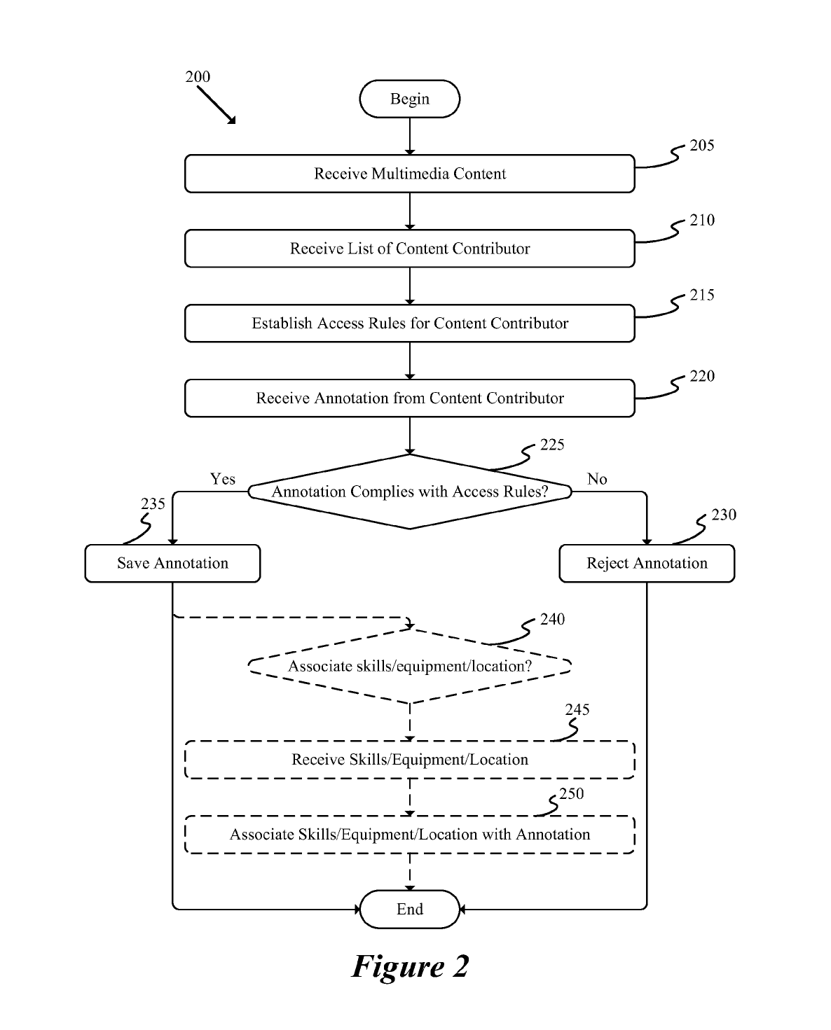

FIG. 2 illustrates a flow chart of an overall process 200 used by some embodiments of the system. The process 200 begins with the system receiving multimedia content (at 205) such as a movie production or short film. Next, the system may receive (at 210) a list of verified content creators that had a role in the production of the media content received by the system. These content creators may be associated with the content and, in some embodiments of the system, their names may be displayed as contributors when a user views the content as a project stored within the system.

After the content creators have been identified (at 210), a set of access rules may be established (at 215) for each content creator as discussed above. The access rules will determine the scope and type of annotations that each of the content contributors may add to the content. Then, the content contributors can view the content based on their access rules and the process 200 is ready to receive annotations (at 220) from the content contributors. At this point, a content contributor may be able to define what portion of the content he wants to annotate. In some embodiments, the content contributor may be provided an annotation tool to navigate to a portion of the content's timeline and select a length of time or a beginning and ending time reference that he wishes to associate with his multimedia annotation/commentary.

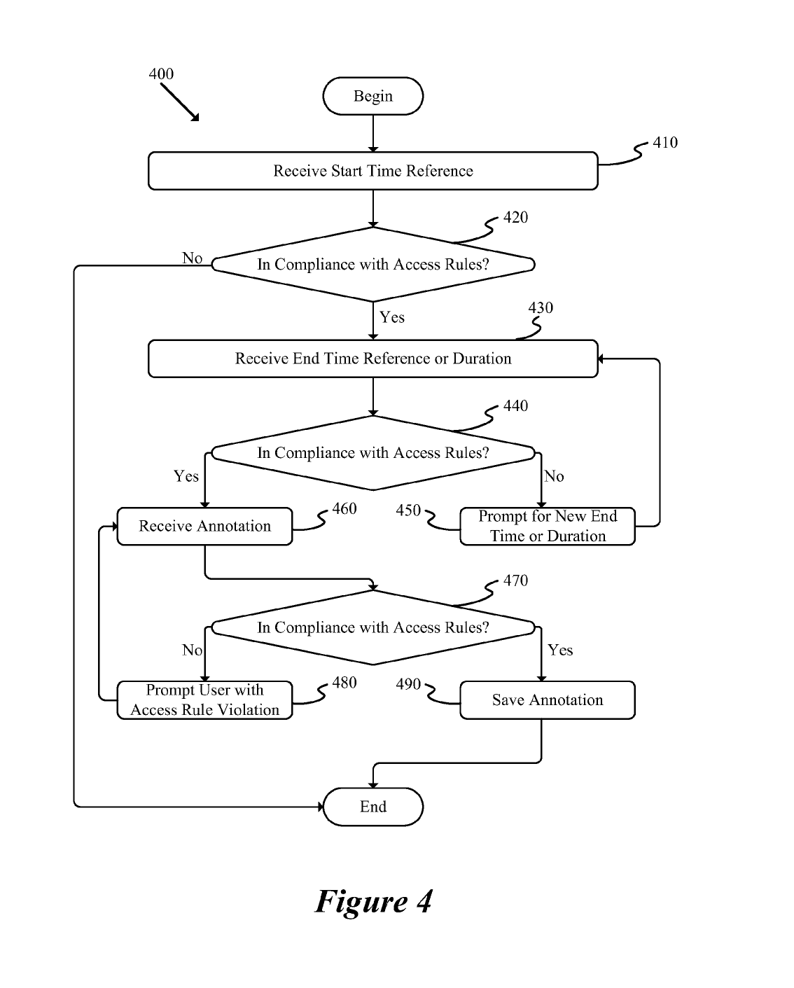

During the creation of an annotation, the process 200 may check (at 225) to see whether the annotation complies with the access rules defined for the content contributor. For example, if the time limit of the scene selected for annotation exceeds the allowed time limit defined in the access rules, the system may reject (at #230) the scene/content selection. In some embodiments, the content contributor may simply be prompted to make a selection that complies with the access rules by shortening the scene selection, for example. If a proper content selection is made, other relevant access rules may also be checked such as the length of the annotation or the current number of annotation made by the content contributor in the current content. If an annotation is not in compliance with the access rules, the process 200 may reject (at 230) the annotation. This annotation process is explained in further detail below with reference to FIG. 4. If the annotation is in compliance with all the access rules assigned to the content contributor, then the process 200 will save (at 235) the annotation and associate the annotation with the relevant portion of content.

In some embodiments, the process 200 may optionally ask the content contributor if he would like to associate certain skills, locations or equipment he used with the annotation. If the contributor chooses not to provide skills/equipment/locations the process 200 ends. If the content contributor wishes to add (at 240) skills and/or equipment and or/locations used in the scene being annotated, the process 200 may provide a default set of skills/equipment/locations etc. for the content contributor to choose from or the content contributor may be able to add new skills/equipment/locations etc. that may not be provided in the system. Finally, the process 200 may save (at 245) and associate (at 250) the entered skills/equipment/location, etc. with the submitted annotation. Some embodiments may also allow the contributors' peers to endorse the skills that the contributor listed as applicable to the annotation. Some embodiments may also limit endorsement only to those that are verified content contributors to the project being annotated. Such limitations may help substantiate the endorsement, wherein the assumption would be that the endorser worked alongside the annotation contributor and therefore is able to properly comment/endorse on behalf of the contributor's work and skills.

One of ordinary skill in the art will recognize that process 200 may be performed in various appropriate ways without departing from the scope of the disclosure. For instance, the process may not be performed as one continuous series of operations in some embodiments. In addition, the process may be implemented using several sub-processes (e.g. subsequent FIG. 4), or as part of a larger macro-process. Furthermore, various processes may be performed concurrently, sequentially, or some combination of sequentially and concurrently. Moreover, the operations of the process may be performed in different orders.

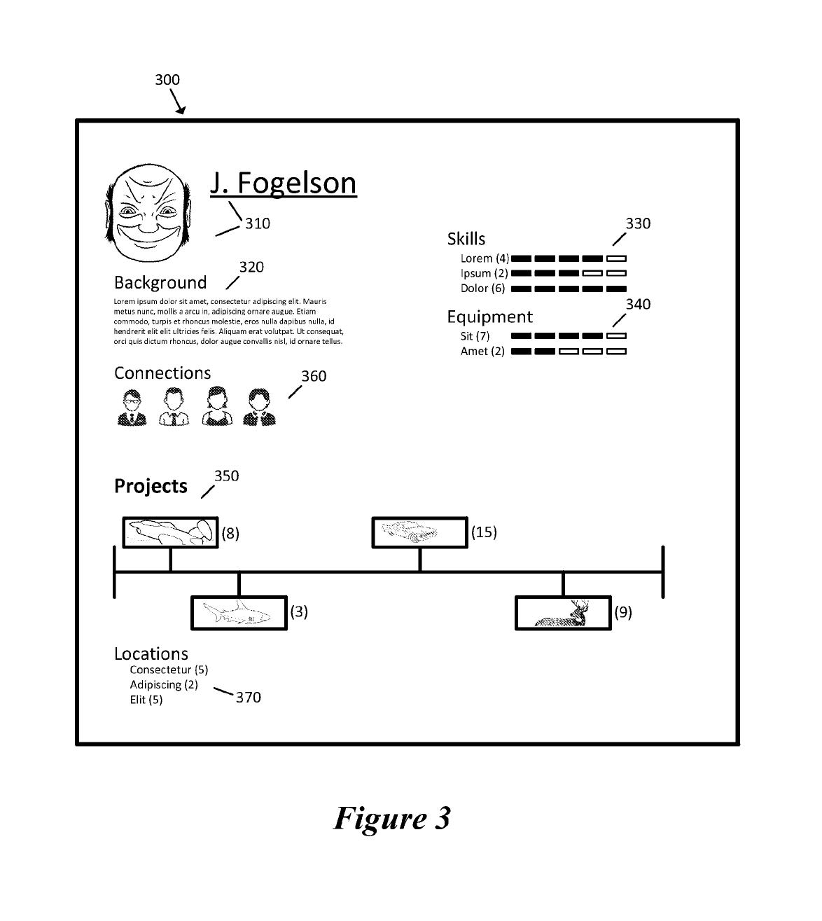

As content creators annotate projects over time with their contributions and/or commentary, their profiles within the system 100 will populate with relevant information and expand over time. FIG. 3 illustrates an exemplary graphical user interface (“GUI”) of a profile for a content creator according to one embodiment of the present disclosure. This profile 300 may grow over time to become a personalized project repository of work and may further act as a media rich and interactive resume that can be provided to and or searched by potential employers or used to match the content creator with existing job opportunities within the system 100. As illustrated, the profile 300 may include the content creators name and picture 310, background information 320 about the content creator, skills 330 and/or equipment 340 possessed by the content creator, projects 350 the individual has been a contributor/collaborator in, connections and/or profiles 360 the content creator has within the system, and location 370 where the content creator may have worked while collaborating on projects.

Some embodiments may display skills 330 and equipment 340 with a numerical reference conveying the number of times the content creator has used that particular skill or piece of equipment in his associated projects (e.g., by tagging annotation as discussed above). Any numerical reference in a profile may also be linked and take a user to a page that displays all the annotations the content creator has associated with that particular attribute. Furthermore, some embodiments may also have endorsements ratings for each skill/equipment illustrating the content creator's expertise as rated by his peers via endorsements. The profile 300 may also display all associated projects 350 where the content creator is a verified contributor. Some embodiments may graphically present the projects along a timeline based on release or completion dates of each project. Furthermore, some embodiments may also indicate the number of annotations the content creator has provided within the project using a numerical reference. In some embodiments, a visitor to the content creator's profile may be able to view the content where only the annotations related to the profile owner are displayed with the content, while navigating to the project page of the content itself may display all the annotations created across all the content contributors for that given project.

One of ordinary skill in the art will recognize that the profile 300 in only one example and that profiles may be implemented in various different ways and/or layouts without departing from the scope of the disclosure. For instance, projects may be displayed in a list format alphabetically, along a timeline based on project start, completion or release dates, in numerical order based on the number of annotations per project, or any combination thereof. In addition, one of ordinary skill in the art will recognize that profiles may be adapted for different uses without departing from the scope of the disclosure. For example, profiles may be made on behalf of groups of collaborators or for companies working in creative services such as set designer or post production companies.

### II. Video Player

Some embodiments of the present disclosure provide a video player 160 adapted for viewing content, creating multimedia annotations to the content, and viewing the annotations in a seamless manner without confusing a viewer. For example, once content is received by the system, a content contributor having sufficient access rights to that content may be able to navigate to any particular place along the content's timeline. From there, a simple annotation tool/control may be invoked to create or view an annotation directly from the timeline.

FIG. 4 illustrates a flow chart of a process 400 used in in some embodiments of the present disclosure for creating a multimedia annotation (e.g. step 220 of FIG. 2). The process 400 may begin when the user (i.e. content contributor) invokes the annotation tool at a specified start time in the content. The process 400 receives (at #410) the starting time reference of the content and subsequently may check (at 420) that the user has not violated an access rule (e.g., check to see that the user will not exceed the number of allowed annotations for the current content). If the user has violated an access rule, the process 400 may end.

The user may then be able to input (at 430) either an end time or duration for the content that he wishes to call out as a reference to the annotation he is about to create. The process 400 may then check (at 440) the duration of the content called out against the access rules for the user. If the duration of the content to be viewed in association with the annotation exceeds the access rules defined for the user, the process 400 may prompt the user (at 450) for a new end time or duration length of the content to be called out. In some embodiments, the system may automatically select the duration or change a selected duration without prompting the user based on his access rules. If the duration of the content does comply with the user's access rules, the user may proceed with uploading his multimedia annotation via file selection from his computing device or record an annotation using his device inputs on the fly for direct upload to the system.

After the process 400 receives the annotation (at 460) another check may be made (at 470) to see whether the annotation complies with the user's access rules (e.g., the duration of the annotation). If an access rules is violated, the user may be prompted (at 480) of the violation and asked to upload another annotation, after which the user can upload another annotation or exit the annotation process. If the annotation complies with the user's access rules, then the annotation may be saved (at 490) and associated with the content at the specified time period called out by the user.

One of ordinary skill in the art will recognize that process 400 may be performed in various appropriate ways without departing from the scope of the disclosure. For instance, the process may not be performed as one continuous series of operations in some embodiments. In addition, the process may be implemented using several sub-processes, or as part of a larger macro-process. Furthermore, various processes may be performed concurrently, sequentially, or some combination of sequentially and concurrently. Moreover, the operations of the process may be performed in different orders.

When a typical user is browsing projects or profiles on the platform, all the annotations saved to the content may be displayed in various ways. For instance, a horizontal timeline spanning the length of the video player may have callouts of where annotation are present. These callouts may be dots, dashes or other visual cues on the timeline indicating that an annotation is present. In some embodiments, hovering over a callout may also display a still image or text preview of the annotation. Other embodiments may show a vertical timeline underneath the main video player with each annotation displayed in a callout box having a preview of the annotation.

While viewing the content (i.e., a video production/project) on the video player, invoking an annotation to play may occur in various ways based on user and/or system preferences. For example, while the user interacts with an annotation, this video player may automatically pause the content so the user is not confused whether he or she is watching the video or interacting with the annotation, which could also be video. Therefore, when a user clicks on an annotation, the annotation may supersede the primary viewing experience and the main video content may fade out in the background. In some embodiments, the annotation may be displayed as a layer on top of the video player while other embodiments may display the annotation underneath the video player in an annotation window or along the timeline where the annotation is located. Furthermore, some embodiments may play a multimedia annotation while the main content is still being played without sound, that is the audio of the annotation supersedes the main content's audio but the main video content continues to be played so the viewer can relate the annotation to the content in real time. In some embodiments the playback of the annotation may also be defined by the content creator making the annotation.

Some embodiments of the video player may also provide annotation controls for viewing annotation. For example, the video player may provide the ability to skip from one annotation to the next along the timeline. In addition to traditional fast forward and rewinding on the video timeline for the main content, these annotation controls may allow a user to easily move forward and backwards through the various annotations.

### III. Multimedia Annotations

The multimedia annotation created by content creators in association with projects and video production within the system may take the form of text, video, audio, PDF or photos and may be visually represented along a video timeline in the form of various color coded icons representing the type of annotation or role of content creator telling the story (e.g. editor, set designer, etc.). The annotations may also be commented on by other verified collaborators of the content, peers, the general community on the platform, or public guests viewing the annotations.

The annotations and/or comments attached to an individual annotation may also reference a timecode within the text of an annotation, for example, by appending the ‘at’ symbol (@) to a timecode (e.g., @01:11:03). The timecode reference may linked where clicking on the timecode will automatically start playback of the main content being referenced in the video player.

Furthermore, annotations may also be color coded or assigned icons based on groupings of content contributors/collaborators. For example, the uploader of the content may be represented by a particular color or icon with respect to his or her annotation on the projects page of the uploaded content while the crew is defined by another color or icon. Other groups may include the platform community (e.g. those not associated as collaborators for the specified content), the general public, a curator of the content, film critics, sound technicians, etc.

### IV. System Architecture

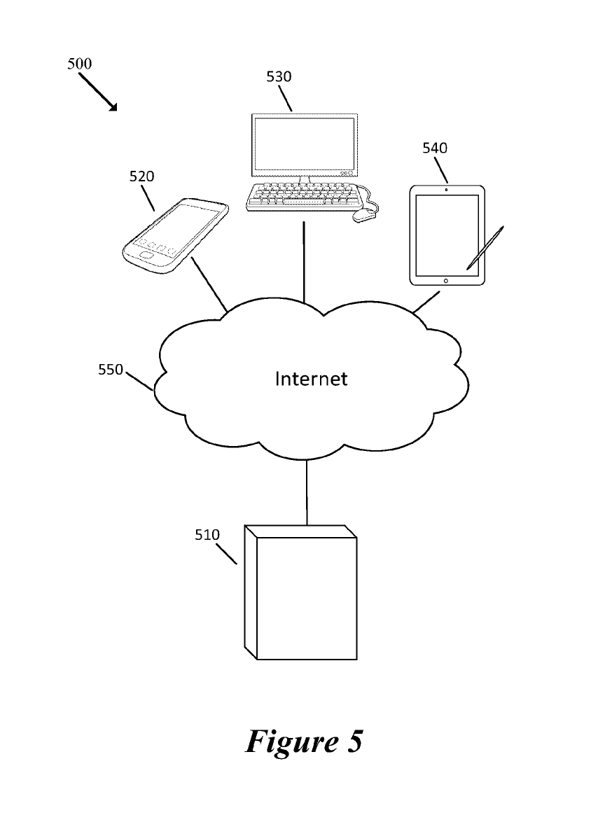

FIG. 5 illustrates an exemplary block diagram of a system 500 for implementing an application that can create a personalized project repository according to some embodiments of the present disclosure. The system 500 includes a server 510 and one or more electronic devices such as smart phones 520, personal computers (PCs) (e.g., desktops or laptops) 530, and tablets 540. The server 520 provides support for the video player as well as hosting for project content and multi-media annotations via the Internet 550. In some embodiments, users may access the video player on the server 520 and provide multi-media annotations using a browser or application on the electronic devices.

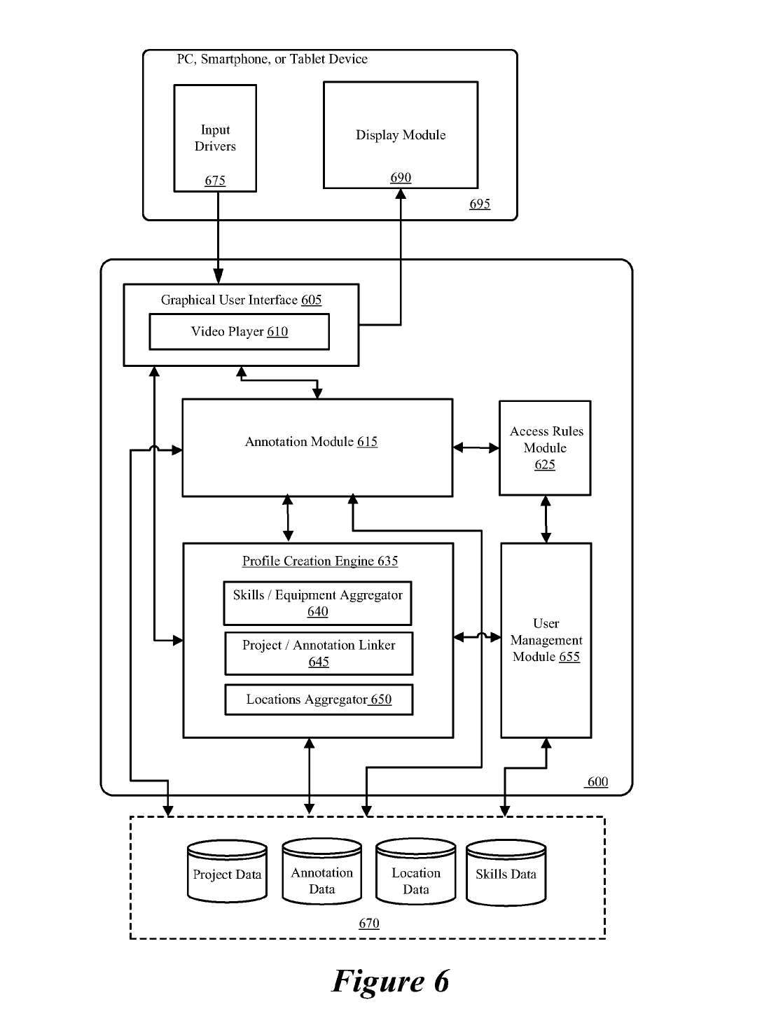

In some embodiments, the above-described operations may be implemented as software running on a particular machine such as a desktop computer, laptop, or handheld device (e.g. smartphone or tablet), or as software stored in a computer readable medium. FIG. 6 illustrates the software architecture of a personalized project repository application 600 in accordance with some embodiments. In some embodiments, the application is a stand-alone application or is integrated into another application (for instance, application 600 might be a portion of a professional network application), while in other embodiments the application might be implemented within an operating system. Furthermore, in some embodiments, the application is provided as part of a server-based (e.g., web-based) solution. In some such embodiments, the application is provided via a thin client. That is, the application runs on a server while a user interacts with the application via a separate client machine remote from the server (e.g., via a browser on the client machine). In other such embodiments, the application is provided via a thick client. That is, the application is distributed from the server to the client machine and runs on the client machine. In still other embodiments, the components (e.g., engines, modules) illustrated in FIG. 6 are split among multiple applications. For instance, in some embodiments, one application may aggregate data to create a content creator profile, while another application maintains annotations and project relationships.

As shown in FIG. 6, the application 600 includes a graphical user interface 605, multimedia annotation module 615, access rules module 625, profile creation module 635, and user management module 655. The graphical user interface 605 may provide a video player 610 having user-interface tools (e.g., display areas, dock controls, etc.) that a user of the application 600 interacts with in order to view content within the system and to create multimedia annotations in association with the media content being viewed in a main display of the video player 610.

As shown in FIG. 6, to facilitate the creation of annotations, the application 600 may include a multimedia annotation module 615. In some embodiments, when the user inputs instructions to create multimedia annotations to media content, the multimedia annotation module 615 receives and processes these instructions in order save and display the annotation in the graphical user interface 605. In addition, the multimedia annotation module 615 may send and receive data to and from an access rules module 625 for verifying whether annotations received from a user are in compliance with rules that govern they types and attributes of annotations created by the user.

As shown in FIG. 6, a profile creation engine 635 of some embodiments includes a skills and/or equipment aggregator 640, a project/annotation linker 645, and a location aggregate 650 that may be used to communicate with the multimedia annotation module 615, the graphical user interface 605, a user management module 655, and/or a set of data storages 670 (e.g., project data, annotation data, location data, skills data, etc.).

Electronic devices (e.g., PCs, smartphones, tablets, etc.) 695 used in conjunction with some embodiments include input drivers 675 for allowing the application 600 to receive data from the device so the application 600 can send multimedia content to a display module 690 of the device (e.g., screen or monitor). In some embodiments, the data sent to the device may be sent via a network or over the Internet.

An example operation of the application 600 will now be described by reference to the components (e.g., engines, modules) illustrated in FIGS. 6. A user may interact with user-interface tools (e.g., annotation controls) in the graphical user interface 605 of the project repository application 600 via input drivers 675 of his device 695 (e.g., a mouse, touchpad, touch screen, etc.) and keyboard (e.g., physical keyboard, virtual keyboard, etc.).

When the user interacts with one or more user-selectable elements (e.g., controls, menu items) in the graphical user interface 605, some embodiments translate the user interaction into input data and send this data to the multimedia annotation module 615. The multimedia annotation module 615 in some embodiments receives the input data and processes the input data in order to create and save annotations to be associated with media content being displayed in the video player 610. For example, when the multimedia annotation module 615 receives instructions for creating an annotation associated with a media clip, the multimedia annotation module 615 may process the input data by identifying the portion of media content and type of annotation received, for example, and saves the annotation. Furthermore, the multimedia annotation module 615 may communicate with the access rules module 625 to ensure that the annotation received from the user does not violate the user's access rules that restrict certain attributes of allowable annotation as described above.

When a user's annotations are saved by the application 600, they can be stored in the set of data storages 670. From the set of data storage 670, the profile creation engine 635 may be able to aggregate several types of data associated with a particular user to create and display a profile via the graphical user interface 605. The user management module 655 may communicate with the profile creation engine 635 to create a personalized project repository for each content creator based on several criteria the content creator may identify as desirable data to display in his or her profile.

It should be recognized by one of ordinary skill in the art that any or all of the components of personalized project repository software 600 may be used in conjunction with the present disclosure. Moreover, one of ordinary skill in the art will appreciate that many other configurations may also be used in conjunction with the present disclosure or components of the present disclosure to achieve the same or similar results.

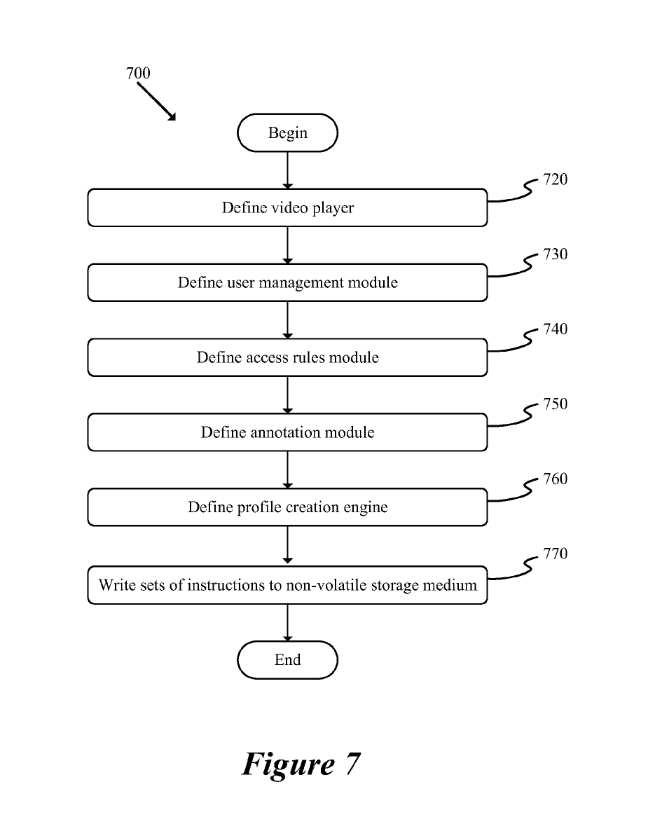

FIG. 7 illustrates a flow chart of a process 700 used by some embodiments to define and store the personalized project repository application of some embodiments. Specifically, process 700 illustrates the operations used to define sets of instructions for providing several of the elements described above in FIG. 1 and for creating a video player with annotation capabilities, a user management module, defining access rules for content creators, a multimedia annotations module, and the creation of a profile for content creators as a personalized project repository. The process 700 may be used to generate a project repository application of some embodiments.

Process 700 may begin with the generation of a computer program product for use by consumers. As shown, the process may define (at 720) sets of instructions for implementing a video player having annotation capabilities (e.g., as described above in reference to Section II). In some cases such sets of instructions are defined in terms of object-oriented programming code. For example, some embodiments may include sets of instructions for defining classes and instantiating various objects at runtime based on the defined classes. The process then defines.

Next, process 700 defines (at 730) sets of instructions for a user management module (e.g., for managing curators, content creators, general public, etc.). Process 700 then defines (at 740) sets of instructions for defining an access rules module for the content creator. Then process 700 defines (at 750) sets of instructions for implementing a multimedia annotations module (e.g., as described above in reference to FIG. 4). The process 700 may then define (at 760) sets of instructions for a profile creation module (e.g., aggregating a specific users annotations, projects, skills, etc. in a graphical user interface as described above in reference to FIG. 3). Finally, the process writes (at 770) the sets of instructions to a storage medium such as, but not limited to, a non-volatile storage medium.

One of ordinary skill in the art will recognize that the various sets of instructions defined by process 700 are not exhaustive of the sets of instructions that could be defined and stored on a computer readable storage medium for a personalized project repository application incorporating some embodiments of the disclosure. In addition, the process 700 is an exemplary process, and the actual implementations may vary. For example, different embodiments may define the various sets of instructions in a different order, may define several sets of instructions in one operation, may decompose the definition of a single set of instructions into multiple operations, etc. In addition, the process 700 may be implemented as several sub-processes or combined with other operations within a macro-process.

### V. Computer System

Many of the processes and modules described above may be implemented as software processes that are specified as at least one set of instructions recorded on a non-transitory storage medium. When these instructions are executed by one or more computational elements (e.g., microprocessors, microcontrollers, Digital Signal Processors (“DSPs”), Application-Specific ICs (“ASICs”), Field Programmable Gate Arrays (“FPGAs”), etc.) the instructions cause the computational element(s) to perform actions specified in the instructions.

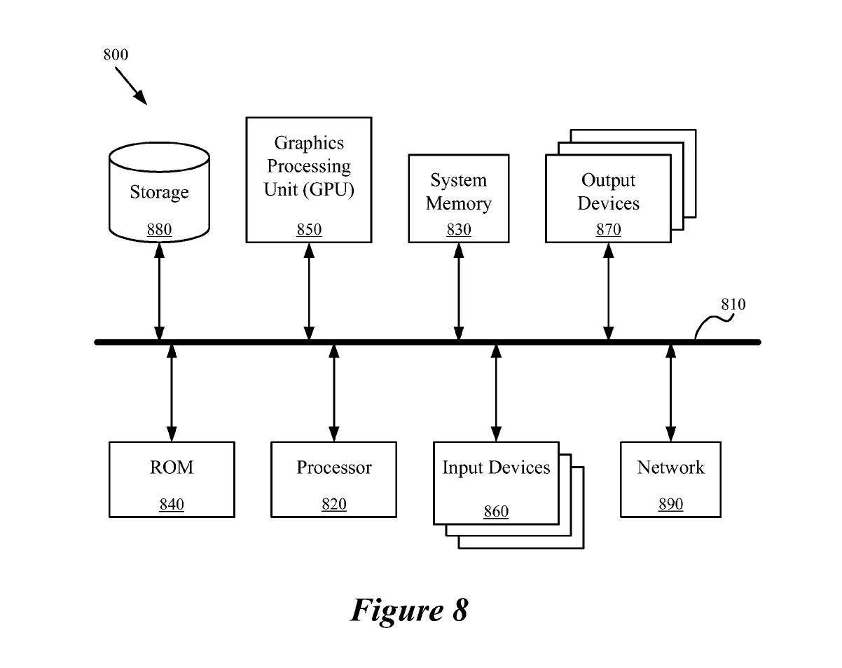

FIG. 8 illustrates a schematic block diagram of a computer system 800 with which some embodiments of the disclosure may be implemented. For example, the system described above in reference to FIG. 1 may be at least partially implemented using computer system 800. As another example, the processes described in reference to FIG. 2 and FIG. 4 may be at least partially implemented using sets of instructions that are executed using computer system 800.

Computer system 800 may be implemented using various appropriate devices. For instance, the computer system may be implemented using one or more personal computers (“PC”), servers, mobile devices (e.g., a Smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

Computer system 800 may include a bus 810, at least one processing element 820, a system memory 830, a read-only memory (“ROM”) 840, other components (e.g., a graphics processing unit) 850, input devices 860, output devices 870, permanent storage devices 880, and/or a network connection 890. The components of computer system 800 may be electronic devices that automatically perform operations based on digital and/or analog input signals.

Bus 810 represents all communication pathways among the elements of computer system 800. Such pathways may include wired, wireless, optical, and/or other appropriate communication pathways. For example, input devices 860 and/or output devices 870 may be coupled to the system 800 using a wireless connection protocol or system. The processor 820 may, in order to execute the processes of some embodiments, retrieve instructions to execute and data to process from components such as system memory 830, ROM 840, and permanent storage device 880. Such instructions and data may be passed over bus 810.

ROM 840 may store static data and instructions that may be used by processor 820 and/or other elements of the computer system. Permanent storage device 880 may be a read-and-write memory device. This device may be a non-volatile memory unit that stores instructions and data even when computer system 800 is off or unpowered. Permanent storage device 110 may include a mass-storage device (such as a magnetic or optical disk and its corresponding disk drive).

Computer system 800 may use a removable storage device and/or a destination storage device as the permanent storage device. System memory 830 may be a volatile read-and-write memory, such as a random access memory (“RAM”). The system memory may store some of the instructions and data that the processor uses at runtime. The sets of instructions and/or data used to implement some embodiments may be stored in the system memory 830, the permanent storage device 880, and/or the read-only memory 840. For example, the various memory units may include instructions for authenticating a client-side application at the server-side application in accordance with some embodiments. Other components 850 may perform various other functions. These functions may include interfacing with various communication devices, systems, and/or protocols.

Input devices 860 may enable a user to communicate information to the computer system and/or manipulate various operations of the system. The input devices may include keyboards, cursor control devices, audio input devices and/or video input devices. Output devices 870 may include printers, displays, and/or audio devices. Some or all of the input and/or output devices may be wirelessly or optically connected to the computer system.

Finally, as shown in FIG. 8, computer system 800 may be coupled to a network through a network adapter 890. For example, computer system 800 may be coupled to a web server on the Internet such that a web browser executing on computer system 800 may interact with the web server as a user interacts with an interface that operates in the web browser.

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 800 may be used in conjunction with the disclosed embodiments. Moreover, one of ordinary skill in the art will appreciate that many other system configurations may also be used in conjunction with the disclosed embodiments or components of the embodiments.

Moreover, while the examples shown may illustrate many individual modules as separate elements, one of ordinary skill in the art would recognize that these modules may be combined into a single functional block or element. One of ordinary skill in the art would also recognize that a single module may be divided into multiple modules.

While the disclosure has been described with reference to numerous specific details, one of ordinary skill in the art will recognize that the disclosure can be embodied in other specific forms without departing from the scope of the disclosure. For example, several embodiments were described above by reference to particular features and/or components. However, one of ordinary skill in the art will realize that other embodiments might be implemented with other types of features and components, and that the disclosure is not to be limited by the foregoing illustrative details.

What is claimed is:

1. A method for creating a repository comprising:
receiving content (205);
receiving an identification of at least one content creator (210) involved in the production of the content;
establishing a set of access rules (215) for the at least one content creator, wherein the access rules limit annotation rights of the at least one content creator;
allowing the at least one content creator to annotate the content (220) with objects based on the access rules; and
generating a profile (300) including a set of annotations with corresponding sections of the content as a repository of an individual content creator.

2. The method of claim 1, wherein the set of access rules are based on at least one of the content creator's contribution to the content and the content creator's role in the creation of the content.

3. The method of claim 1, wherein the access rules comprise a temporal limit for the content to be associated with the annotation.

4. The method of claim 1, wherein the access rules comprise a limit on the number of annotations allowed by the content creator for the content.

5. The method of claim 1, wherein the access rules comprise a limit on the length of the annotation.

6. The method of claim 1, wherein the set of access rules limit the type of objects allowed to be used in conjunction with an annotation.

7. The method of claim 1, wherein the object includes a timecode reference link for playing the content at a specified temporal location.

8. An apparatus for creating a repository comprising:
a storage (880) for storing content and a set of content creators corresponding to the content;
a memory (830) for storing sets of instructions;
a processor (820) for executing the sets of instructions, wherein the processor:
defines a set of access rules for each content creator, wherein the access rules limit annotation rights of the content creators;
evaluates whether annotations received from the content creators are in compliance with the set of access rules;
allows annotations to be stored in the storage if the annotations are in compliance with the set of access rules; and
generates a profile that includes an aggregation of annotations and associated content as a repository.

9. The apparatus of claim 8, wherein the memory further comprises sets of instructions for defining access rules based on at least one of the content creator's contribution to the content and the content creator's role in the creation of the content.

10. The apparatus of claim 8, wherein the memory further comprises sets of instructions for defining access rules that set temporal limits for the content to be associated with the annotation.

11. The apparatus of claim 8, wherein the memory further comprises sets of instructions for defining access rules to limit on the number of annotations allowed by the content creator for the content.

12. The apparatus of claim 8, wherein the memory further comprises sets of instructions for defining access rules to limit the length of the annotation.

13. The apparatus of claim 8 further comprising a network connection for transmitting content and annotations to the storage.

14. A non-transitory computer readable medium storing a repository application for execution by at least one processor, the repository application comprising sets of instructions for:
defining a video player (610, 720), wherein the video player comprises controls for creating annotations to content being viewed in the video player;
defining a user management module (655, 730) for managing different categories of content creators;
defining an access rules module (625, 740) for limiting annotation rights made using the video player;
defining an annotation module (615, 750) for creating annotations in association with the content; and
defining a profile creation engine (635, 760) for aggregating content creator annotations.

15. The non-transitory computer readable storage medium of claim 14, wherein the controls of the video player comprises controls for creating an annotation directly from a timeline of the video player.

16. The non-transitory computer readable storage medium of claim 14, wherein the user management module further manages a community of users that are not content creators.

17. The non-transitory computer readable storage medium of claim 14, wherein the access rules module establishes rules for limiting the type of annotations made by content creators.

18. The non-transitory computer readable storage medium of claim 14, wherein the access rules module establishes rules for limiting the length of annotations made by content creators.

19. The non-transitory computer readable storage medium of claim 14, wherein the access rules module establishes rules for limiting the number of annotations made by content creators.

20. The non-transitory computer readable storage medium of claim 14, wherein the profile creation module further aggregates one or more skills, equipment, and locations associated with a content creator.
